(19) United States
(12) Patent Application Publication
(10) Pub. No.: US 2009/0065483 A1
(43) Pub. Date: Mar. 12, 2009

(54) WIRE ELECTRIC DISCHARGE MACHINING METHOD

(75) Inventor: Yasushi Hayashi, San Jose, CA (US)

Correspondence Address: MCDERMOTT WILL & EMERY LLP, 18191 VON KARMAN AVE., SUITE 500, IRVINE, CA, 92612-7108, US

(73) Assignee: SODICK CO., LTD., Yokohama , Kanagawa (JP)

(21) Appl. No.: 11/816,659

(22) PCT Filed: Mar. 3, 2006
(86) PCT No.: PCT/JP2006/304663

§ 371 Date: Nov. 12, 2008

(30) Foreign Application Priority Data
Mar. 3, 2005 (JP) 2005-058393

(51) Int. Cl. B23H 7/00

(52) U.S. Cl. 219/69.17

(57) ABSTRACT

A wire electric discharge machining method for cutting a workpiece while moving a wire electrode, supported between upper and lower wire guides substantially perpendicular to a horizontal program plane, along a program path (PQ) having a start point (P) and an end point (Q) on the program plane. The method of the present invention includes a step of varying a taper angle command (θ) within the program path; a step of acquiring a set allowable error (ε); a step of obtaining one or more dividing points (D1-Dn) for equally dividing the program path so that a maximum error (λmax) of correction amount is lower than or equal to the set allowable error; and a step of correcting position of at least one of the upper wire guide and lower wire guide at each dividing point by a correction amount (Δ).

### TECHNICAL FIELD

The present invention relates to a wire electric discharge machining method, for cutting a workpiece while moving a wire electrode that is supported between a pair of wire guides substantially perpendicular to a horizontal program plane, along a program path on the program plane. The present invention particularly relates to a wire electric discharge machining method for performing a taper cut on a workpiece, with a wire electrode tilted between a pair of wire guides.

### BACKGROUND OF THE INVENTION

Generally, a wire electrode is vertically supported between upper and lower wire guides, and the two wire guides are capable of movement in a horizontal XY plane relative to a workpiece. Cutting that is carried out using a wire electrode that is tilted by moving one wire guide relative to the other is called taper cut. With many wire electric discharge machines, an upper wire guide can move in a horizontal UV plane with respect to the lower wire guide. A wire electrode is mainly made from material such as brass, tungsten or steel, and has a certain degree of rigidity.

Dies having round holes through which the wire electrode passes formed therein are generally used as wire guides. Japanese Patent Publication No. 62-40126 discloses a wire guide having an arc-shaped cross section that can carry out taper cut following a large taper angle with high accuracy. Such a wire guide having a radius of curvature r is shown in FIG. 8. The single dot dashed line in the drawing represents the center of the wire guide, and the reference numeral VL represents a line orthogonal to the program plane. A wire electrode supported between the upper and lower wire guides is tilted by a taper angle command θ from the line VL. Reference numeral Ka represents a turning point at which the taper angle is actually formed. A taper angle command θ in the NC program is based on a nominal turning point Kr. The actual turning point Ka deviates by a displacement δ from the nominal turning point Kr, depending on the taper angle θ. As a result, the shape accuracy of the actual taper angle φ is lowered. There is therefore a need to correct the wire guide position on the horizontal plane depending on the taper angle θ. Δy is correction amount for the lower wire guide position, and Δv is a correction amount for the upper wire guide position.

FIG. 9 shows a main program path PQ of the wire electrode, and a secondary program path RS. The main program path PQ is the path of the wire electrode on the main program plane i. The main program plane is a horizontal plane having the same height as the workpiece upper surface, for example. The secondary program path RS is the path of the wire electrode on the secondary program plane ii. The secondary program plane is a horizontal plane having the same height as the workpiece lower surface, for example. As shown in FIG. 8, the taper angle is gradually varied within the program block that moves the wire electrode from the point P to the point Q. Japanese patent publications 3101596 and 3288799 disclose a method for correcting wire guide position every specified time while advancing such a program block. However, if the movement speed of the wire electrode while advancing one program block is varied, there will be deviation in the position for which correction is carried out.

An object of the present invention is to provide a wire electric discharge machining method that can correct a wire guide position at high shape accuracy, when taper angle varies within a single program block.

Another object of the present invention is to provide a wire electric discharge machining method that prevents correction of wire guide position being carried out too often, when taper angle varies within a single program block.

### DISCLOSURE OF THE INVENTION

According to the present invention, a wire electric discharge machining method for cutting a workpiece while moving a wire electrode, supported between upper and lower wire guides substantially perpendicular to a horizontal program plane, along at least one partial program path (PQ) having a start point (P) and an end point (Q) on the program plane, includes:

a step of varying a taper angle command (θ) within the program path;

a step of acquiring a set allowable error (ε);

a step of obtaining one or more dividing points (D1-Dn) for equally dividing the program path so that a maximum error (λmax) of correction amount is lower than or equal to the set allowable error; and

a step of correcting position of at least one of the upper wire guide and lower wire guide at each dividing point by a correction amount (Δ).

Preferably, the correction amount is obtained based on displacement (δ) of a turning point where the taper angle is formed.

Other novel features of the invention will be described in the following description.

### BRIEF DESCRIPTION OF THE DRAWINGS

FIG. 1 is a flowchart showing a wire electric discharge machining method of the present invention.

FIG. 2A-FIG. 2H are diagrams of a main program path and a secondary program path for taper cut projected on a horizontal plane.

FIG. 3 is a drawing showing correction amounts varying from start point to end point.

FIG. 4 is a graph with measured value for turning point displacement plotted as a function of taper angle command.

FIG. 5 is a graph with measured value for wire guide displacement correction amount plotted as a function of taper angle command.

FIG. 6 is a graph with measured turning point displacement in a wire guide having an arc shaped cross section plotted as a function of taper angle command.

FIG. 7 is a graph showing correction amounts varying from start point to end point.

FIG. 8 is a drawing showing a wire electrode tilted between upper and lower wire guides.

FIG. 9 is a drawing showing a program path of a wire electrode for taper cut.

### DETAILED DESCRIPTION OF THE PREFERRED EMBODIMENTS

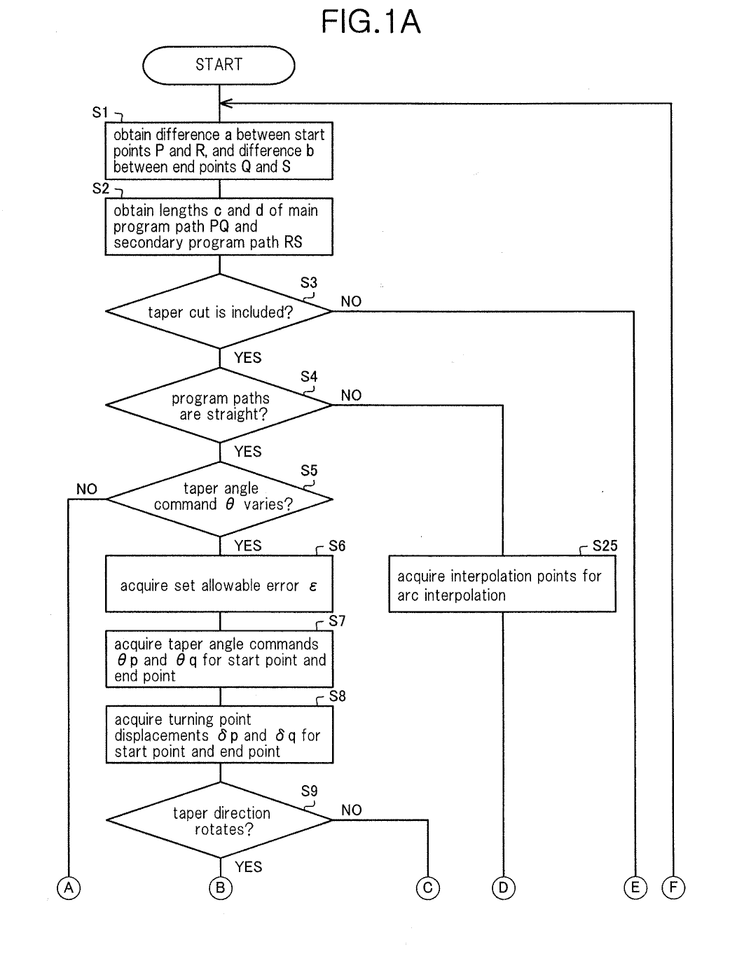

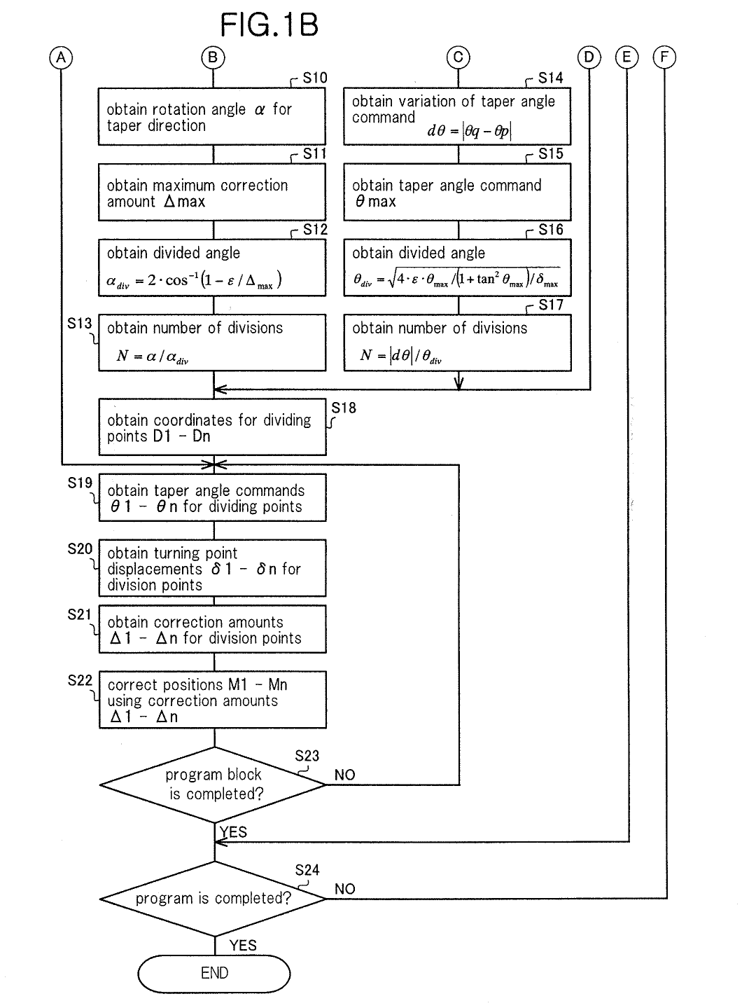

A wire electric discharge machining method of the present invention will be described in the following with reference to FIGS. 1A, 1B, 2A-2H, 3, 4, 5, 6, 7, 8 and 9. A wire electric discharge machine in which an upper wire guide moves in a UV plane relative to a lower wire guide in order to perform taper cut will be used as an example. The process of FIG. 1A and FIG. 1B is mainly executed in a processing unit of the wire electrode discharge machine after an NC program has been decoded.

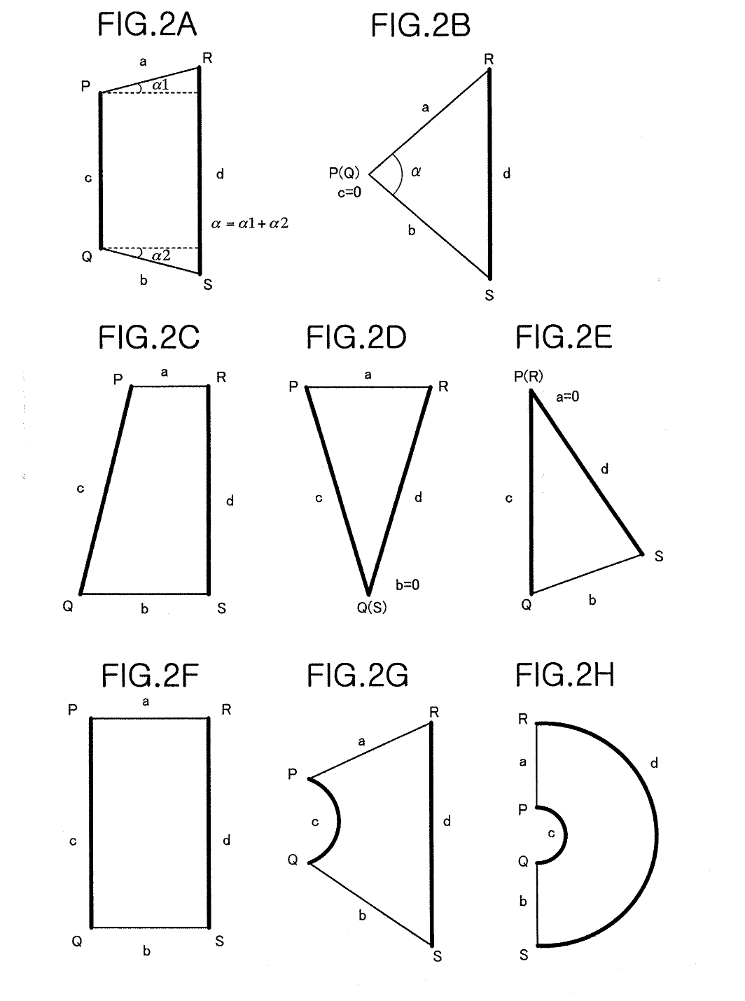

In step S1 of FIG. 1A, a difference a between a start point P of the main program path and a start point R of the secondary program path is obtained. As shown in FIG. 2E, the wire electrode at the time when the difference a is zero is vertical at start point P. Also, a difference b between an end point Q of the main program path and an end point S of the secondary program path is obtained. As shown in FIG. 2D, the wire electrode at the time when the difference b is zero is vertical at end point Q. Position differences a and b are obtained based on coordinates (x, y, u, v) of each point P, Q, R and S. In step S2, the length c of the main program path PQ, and the length d of the secondary program path RS are obtained based on the coordinates (x, y, u, v) of each point P, Q, R and S. In step S3, it is determined, based on the lengths a and b, whether or not a taper cut is included in the program block. When a taper cut is included in the program block, the process advances to step S4. Otherwise, namely when the lengths a and b are both zero, the process advances to step S24. In step S4, if the main program path PQ and the secondary program path RS are both straight, the process advances to step S5. Otherwise, if it is determined that one of the program paths PQ and RS includes an arc, the process advances to step S25. FIG. 2G and FIG. 2H show examples of a program path including an arc. In step S25, interpolation points for arc interpolation are obtained. In step S5, whether or not a taper angle command θ varies in the program block is determined based on values a, b, c and d. If it is determined that the taper angle θ varies in the program block, the process advances to step S6. With the program path in FIG. 2F, the values a and b are equal, and the values c and d are equal. In this case, it is determined that the taper angle θ is constant in the program block, and the process advances to step S18. In step S6, a set value for allowable error ε is obtained. Preferably, the allowable error ε is set to half the desired shape accuracy e (μm). A minimum value for shape accuracy e depends on the minimum drive unit k of the wire electric discharge machine. Accordingly, allowable error ε can be set by means of equation (1), for example.

ε=k/2 (1)

Alternatively, it is possible to set the allowable error ε taking into consideration movement amount in the horizontal direction corresponding to the minimum unit of the taper angle command θ. In step S7, taper angle command θp at start point P and taper angle command θq at end point Q are acquired. In step S8, turning point displacement δp at start point P and turning point displacement δq at end point Q are acquired. Displacement δ (μm) is obtained using well known equation (2).

δ=r·(1/cos θ−1) (2)

The displacement δp and δq may also be extracted from a database in which taper angle command θ and turning point displacement δ are correlated. If it is determined in step S9 that the taper direction rotates in the program block, the process advances to step S10. When the wire electrode moves on the program paths shown in FIG. 2A and FIG. 2B, the process advances to step S10. When the wire electrode moves on the program paths shown in FIG. 2C, FIG. 2D and FIG. 2E, the process advances to step S14.

In step S10, rotation angle α of the taper direction is obtained. Rotation angle α is the angle formed by line PR and line QS, as shown in FIG. 2A and FIG. 2B. Correction amount Δp for starting point P and correction amount Δq for end point Q are obtained by means of equation (3) based on turning point displacements δp and δq.

Δ=δtan θ (3)

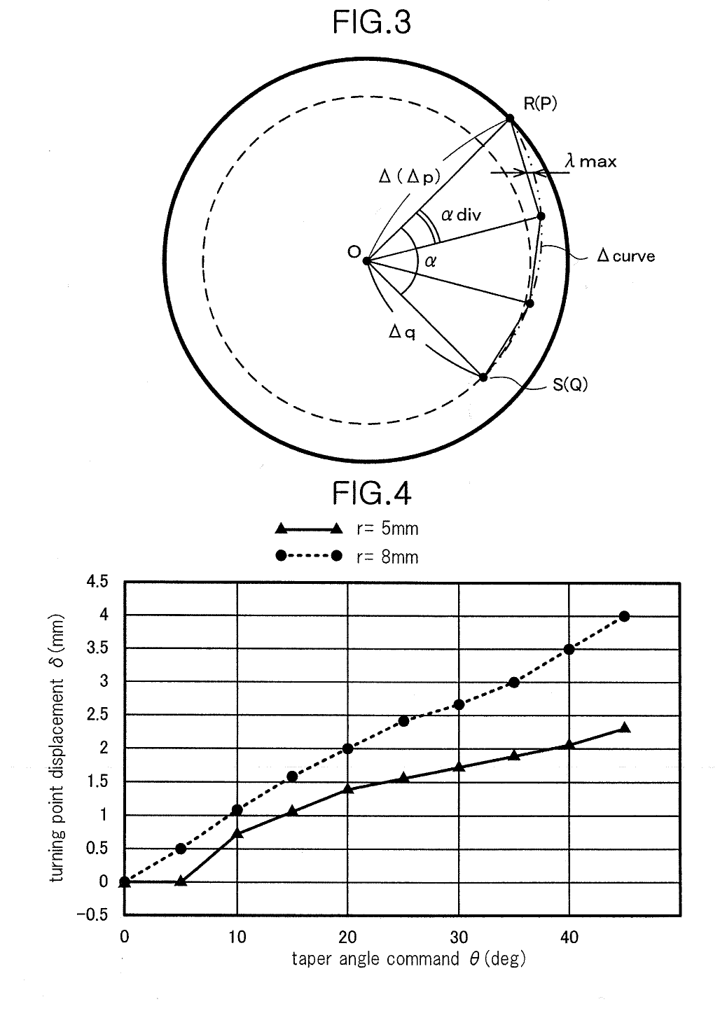

Rotation angle α and correction amount Δp and Δq are shown in FIG. 3. In the drawing, the radius of the solid line circle represents correction amount Δp, while the radius of the dotted line circle represents correction amount Δp. A curved line Δcurve representing correction amount varying from start point R to end point S is shown using an imaginary line. In the drawing, rotation angle α is divided equally into three. αdiv represents an equally divided angle. The curved line Δcurve is also equally divided into three arc-shaped segments. λmax represents the maximum value of error λ between an arc-shaped segment and an approximate straight line. Divided angle αdiv must be obtained so that the maximum value λmax is reliably made the allowable error ε or less. Accordingly, the maximum value Δmax for correction amount is obtained in step S11, and the equally divided angle αdiv is obtained in step S12 by means of equation (4).

α_{div}=2·cos⁻¹(1−ε/Δₘₐₓ) (4)

The Correction amount Δmax is the largest of the Correction amounts Δp and Δq, as shown in FIG. 3. Further, in step S13 a number of divisions N is obtained by means of equation (5).

N=α/α_{div} (5)

The number of divisions N is a natural number following a specified rule.

When the taper direction does not rotate in the program block, variation dθ of the taper angle command is obtained in step S14 by means of equation (6).

dθ=|θq−θp (6)

Steps S15, S16 and S17 will be described in the following assuming the program path of FIG. 2C.

For the closest dividing point Dn to end point Q, taper angle is made θn, and turning point displacement is made δn. Correction amount Δn for dividing point Dn is obtained by means of equation (7).

Δₙ=δₙ·tan θₙ (7)

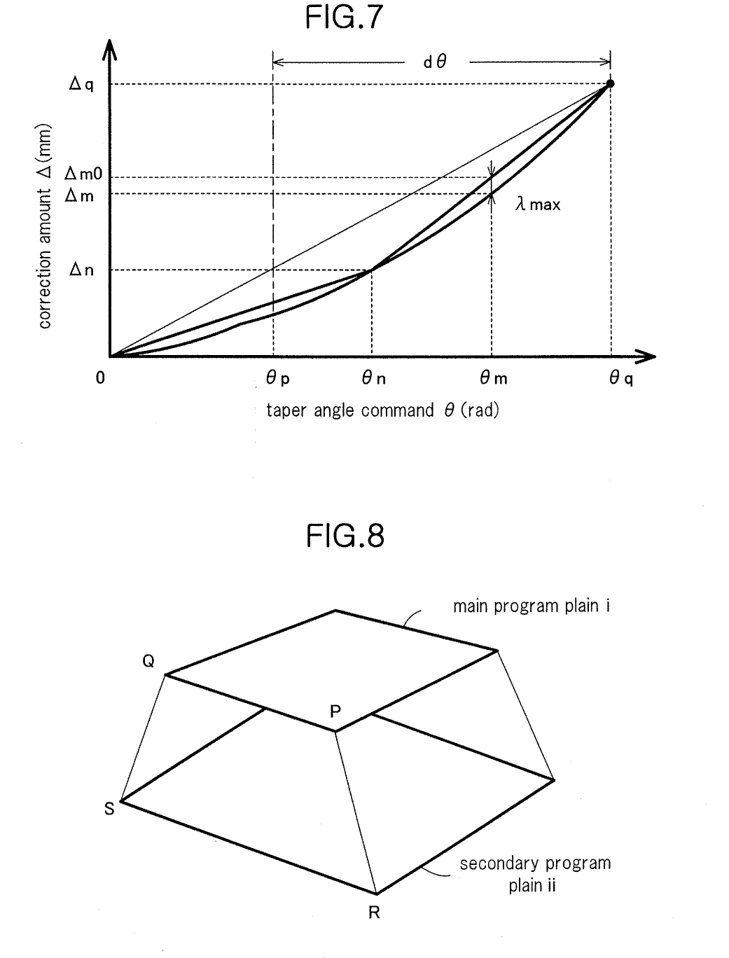

As shown in FIG. 4, turning point displacement 6 in wire guides having an arc-shaped cross section was measured. Wire guides having radius of curvature r of 5 mm and 8 mm were used in the measurement. In the drawing, measurement values are plotted as a function of taper angle command θ. Effective taper angles of from 5 to 45 degrees were tested. As a result of the measurements, turning point displacement δ generally increased proportionally with taper angle command θ, regardless of the radius of curvature r. Accordingly, δmax is obtained by means of equation (8), based on the graph of FIG. 7.

δₙ=δ_{q}·θₙ/θ_{q} (8)

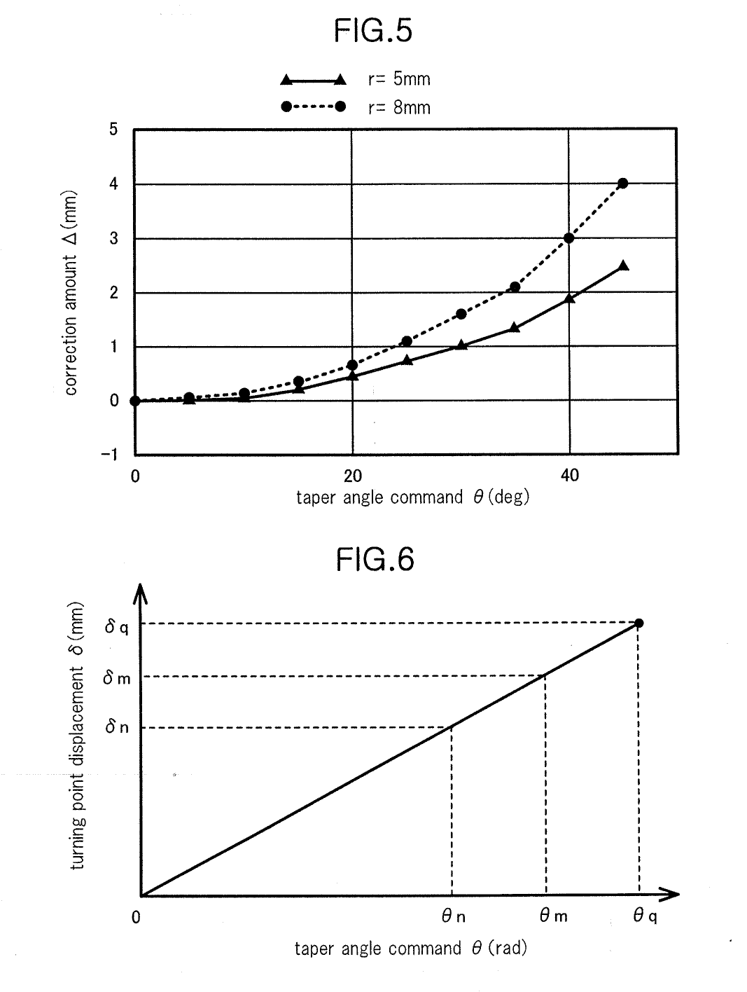

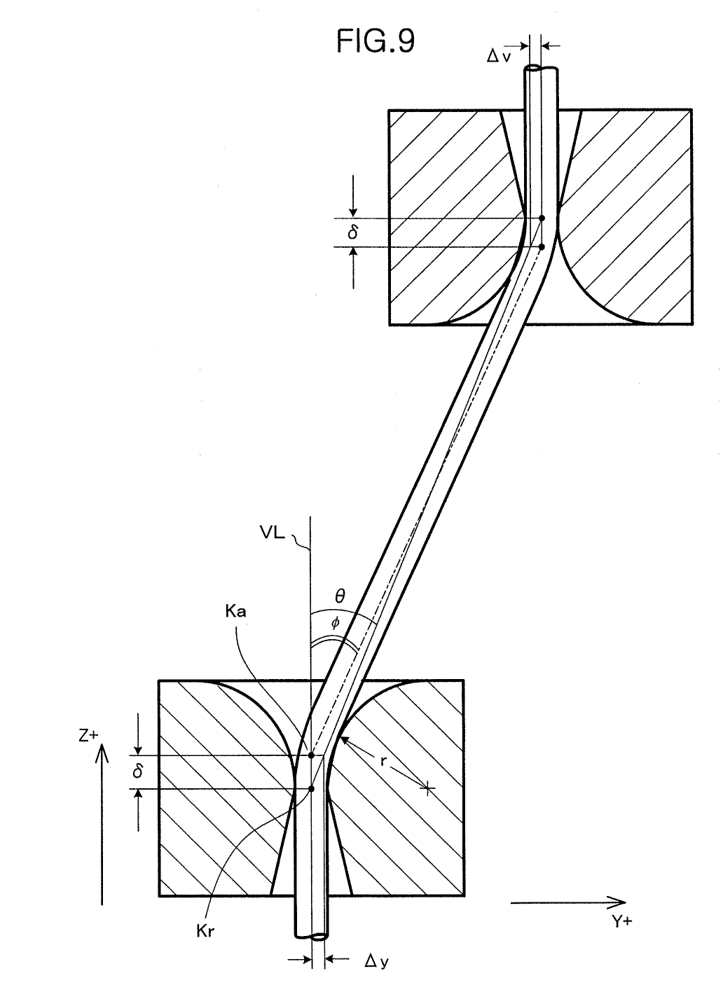

Further, as shown in FIG. 5, Correction amount Δ was measured using the same two types of wire guides. Correction amount Δ gradually increased with respect to taper angle command θ. Therefore, as shown in FIG. 8, error λ appears as a maximum value λmax at an intermediate point between dividing point Dn and end point Q. Taper angle command was θm at that intermediate point. Correction amount Δm0 when taper angle command is θm is obtained by means of equation (9) using first-order interpolation of Δn.

Δₘ₀=(Δ_{q}−Δₙ)/2+Δₙ (9)

Correction amount Δm is obtained by means of equation (10).

Δₘ=(Δ_{q}·tan θₘ+δₙ·tan θₘ)/2 (10)

Δm0 is the sum of Δm and λmax, and so the maximum error λmax is obtained by means of equation (11).

λₘₐₓ={δ_{q}·(tan θ_{q}−tan θₘ)+δₙ·(tan θₙ−tan θₘ)}/2 (11)

From equation (12) below, maximum error λmax is obtained by means of equation (13).

tan θ_{q}−tan θₘ≈tan θₙ−tan θₘ (12)

λₘₐₓ=(tan θ_{q}−tan θₘ)·θ_{q}/2θ_{div} (13)

From equation (14) below, maximum error λmax is obtained by means of equation (15).

tan θ_{q}−tan θₘ≈θ_{q}/(2/n)·(1+tan² θ_{q}) (14)

λₘₐₓ=θ_{q}/2n·(1+tan² θ_{q})·δ_{q}/2n (15)

Divided angle θdiv which is variation of taper angle command dθ divided by number of divisions N, is obtained by means of equation (16).

θ_{div}=\sqrt{4·λₘₐₓ·θ_{q}/(1+tan² θ_{q})/δ_{q}} (16)

Equally divided angle θdiv must be obtained so that the maximum value λmax is reliably made the allowable error ε or less. Accordingly, the maximum value θmax for taper angle command is obtained in step S15, and the divided angle θdiv is obtained in step S16 by means of equation (17).

θ_{div}=\sqrt{4·ε·θₘₐₓ/(1+tan² θₘₐₓ)/δₘₐₓ} (17)

The maximum value θmax for taper angle command is the largest of the taper angle commands Δp and Δq. δmax is turning point displacement when taper angle command is the maximum value θmax. In step S17 a number of divisions N is obtained by means of equation (18).

N=|dθ|/θ_{div} (18)

The number of divisions N is a natural number following a specified rule.

In step S18, the program path is equally divided by a number of divisions N, and coordinates for dividing points D1-Dn are obtained. n is N−1. In step S19, taper angle commands θ1-θn for dividing points D1-Dn are obtained based on taper angles θp and θq. In the event that interpolation points for arc interpolation have been acquired in step S25, the interpolation points are used as dividing points D1-Dn. In step S20, turning point displacements δ1-δn for dividing points D1-Dn are obtained. In step S21, correction amounts Δ1-Δn for dividing points D1-Dn are obtained. In step S22, correction amounts Δ1-Δn are respectively distributed to correction amounts for the X, Y, U and V directions based on taper direction etc. Coordinates of the dividing points D1-Dn are corrected using correction amounts for the X, Y, U and V directions. In step S23, if the program block is completed, the process advances to step S24. Otherwise, the process returns to step S3. If the NC program is completed in the step S24, the process ends. Otherwise, the process returns to step S1.

The embodiments have been chosen in order to explain the principles of the invention and its practical applications, and many modifications are possible in light of the above teaching. It is intended that the scope of the invention be defined by the claims appended hereto.

1. A wire electric discharge machining method for cutting a workpiece while moving a wire electrode, supported between upper and lower wire guides substantially perpendicular to a horizontal program plane, along at least one partial program path having a start point and an end point on the program plane, includes:
a step of varying a taper angle command within the program path;
a step of acquiring a set allowable error;
a step of obtaining one or more dividing points for equally dividing the program path; and
a step of correcting position of at least one of the upper wire guide and lower wire guide at each dividing point by a correction amount;
wherein a maximum error of the correction amount is lower than or equal to the set allowable error.

2. The wire electric discharge machining method of claim 1, wherein the correction amount is obtained based on displacement of a turning point at which the taper angle is formed.

3. The wire electric discharge machining method of claim 1, further comprising a step of obtaining a number of two or more divisions by which the program path is equally divided.

4. The wire electric discharge machining method of claim 3, further comprising:
a step of obtaining variation of taper angle command; and
a step of obtaining a divided angle for the variation of taper angle command so that a maximum error of the correction amount is lower than or equal to the set allowable error;
wherein the step of obtaining a number of divisions includes a step of dividing the variation of taper angle command by the divided angle.

5. The wire electric discharge machining method of claim 3, further comprising:
a step of rotating a taper direction within the program path;
a step of obtaining a rotation angle of the taper direction;
a step of obtaining a divided angle for the rotation angle of the taper direction so that a maximum error of the correction amount is lower than or equal to the set allowable error; and
wherein the step of obtaining a number of divisions includes a step of dividing the rotation angle of the taper direction by the divided angle.
